(19) United States
(12) Patent Application Publication
(10) Pub. No.: US 2006/0057051 A1
(43) Pub. Date: Mar. 16, 2006

(54) Highly ordered porous carbon materials having well defined nanostructures and method of synthesis

(76) Inventors: Sheng Dai, Knoxville, TN (US); Chengdu Liang, Knoxville, TN (US)

Correspondence Address: UT-Battelle, LLC;Office of Intellectual Property, One Bethal Valley Road, 4500N, MS-6258, Oak Ridge, TN, 37831, US

(21) Appl. No.: 10/938,895

(22) Filed: Sep. 10, 2004

(51) Int. Cl. C01B 31/02

(52) U.S. Cl. 423/445 R

(57) ABSTRACT

Applicant's present invention comprises a method for fabricating porous carbon materials having highly ordered nanostructures comprising the steps of first, forming a precursor solution comprising a block copolymer template and a carbon precursor; second, forming a self-assembled nanostructured material from the precursor solution; third annealing the nanostructured material thereby forming a highly ordered nanostructured material; fourth, polymerizing the carbon precursor to cure the nanostructured material; and pyrolyzing the nanostructured material wherein the block copolymer template is decomposed to generate ordered carbon nanopores and the nanostructured material is carbonized to form the walls of the carbon nanopores thereby forming a porous carbon material having a highly ordered nanostructure. In addition, the present invention further comprises a porous carbon material comprising a carbon nanostructure having ordered carbon nanopores that have uniform pore sizes ranging from about 4.5 nm up to about 100 nm.

The United States government has rights in this invention pursuant to contract no. DE-AC05-00OR22725 between the United States Department of Energy and UT-Battelle, LLC.

### FIELD OF THE INVENTION

The present invention relates to porous carbon materials and more particularly, to highly ordered porous carbon materials having well defined nanostructures.

### BACKGROUND OF THE INVENTION

Elemental carbon materials exhibit unique electron, mechanical, and chemical properties that make them attractive materials for nanoelectronic devices, strength-enhancing materials, separation media, catalyst supports, energy storage/conversion systems (hydrogen storage, fuel cell electrodes, etc.), proximal probes, optical components, etc. Well-defined nanoporous carbon materials are essential for a number of the aforementioned applications. Although numerous methods have been developed for the fabrication of carbon films such as chemical vapor deposition, ultrasonic deposition, hydrothermal decomposition of carbide compound, polymer coating and pyrolysis, no ordered nanostructure has been obtained by these methods. Ordered porous carbon materials have previously been replicated using colloidal crystals and presynthesized mesoporous silicas as scaffolds. These methodologies are extremely difficult to adapt to the fabrication of large-scale ordered nanoporous films with controlled pore orientations. Currently, well defined carbon nanostructures can only be made by using inorganic nanostructures as templates such as porous silica, silica nanospheres, and anodic alumina disk. Five major problems associate with the current template-tailored method. First, the preparation and removal of the inorganic templates is a very wasteful procedure. Second, the removal of the templates requires etching agents, which are harmful to the substrates. The etching agents can usually peel carbon films off the substrates. So far, no ordered nanoporous carbon film has been made of well defined nanostructure on substrates. Third, although well defined nanostructured free-standing carbon films may be produced by using the current template-tailored method, the large scale alignment of the carbon nanostructures is still a big challenge. Fourth, the residual of the templates is the major impurity of the carbon five. Fifth, both the structural morphology and the dimension of the repeating units of the carbon nanostructures are highly limited by the available templates.

### OBJECTS OF THE INVENTION

Accordingly, it is an object of the present invention to provide highly ordered porous carbon materials having well defined nanostructures.

It is another object of the present invention to provide highly ordered crack-free mesoporous carbon films having ordered carbon nanopores having uniform pore sizes and homogeneous film thickness.

It is yet another object of the present invention to provide highly ordered nanoporous carbon films with controlled pore orientation.

It is still yet another object of the present invention to provide a method for making highly ordered crack-free porous carbon materials that have uniform pore sizes utilizing self-assembled block copolymers as structure-directing agents.

These and other objects, features and advantages of the present invention will become apparent after a review of the following detailed description of the disclosed embodiments and the appended claims.

### SUMMARY OF THE INVENTION

In accordance with one aspect of the present invention, the foregoing and other objects are achieved by a method for fabricating porous carbon materials having highly ordered nanostructures comprising the steps of a) forming a precursor solution comprising a block copolymer template and a carbon precursor wherein the carbon precursor is spatially arranged and organized; b) forming a self-assembled nanostructured material from the precursor solution; c) annealing the nanostructured material to form a highly ordered nanostructured material; d) polymerizing the carbon precursor to cure the nanostructured material; and e) pyrolyzing the nanostructured material wherein the block copolymer template is decomposed to generate ordered carbon nanopores and the nanostructured material is carbonized to form the walls of the carbon nanopores thereby forming a porous carbon material having a highly ordered nanostructure.

In accordance with another aspect of the present invention, other objects are achieved by a porous carbon material comprising a carbon nanostructure having ordered carbon nanopores that have uniform pore sizes ranging from about 4.5 nm up to about 100 nm.

### BRIEF DESCRIPTION OF THE DRAWINGS

In the drawings:

FIG. 1 shows a comparison of the Fourier transform infrared (FTIR) spectra of polystyrene-b-poly(4-vinylpyridine) (lower spectra) and the FTIR spectra of polystyrene-b-poly(4-vinylpyridine)/resorcinol mixture (molar ratio of pyridine groups to resorcinol is 1:1).

FIG. 2 shows the thermograms and the derivative thermograms of four samples: (1) polystyrene-b-poly(4-vinylpyridine), (2) polystyrene-b-poly(4-vinylpyridine)/resorcinol mixture, (3) resorcinol formaldehyde resin, and (4) polystyrene-b-poly(4-vinylpyridine) and resorcinol formaldehyde resin.

FIG. 3A is an electron microscopy Z contrast image of the large scale homogeneous carbon film in a 4×3 μm area; the scale bar is 1 μm.

FIG. 3B is an electron microscopy Z contrast image of the carbon film showing the details of the highly ordered carbon structure.

FIG. 3C shows the Fourier Transform of the image shown in FIG. 3B.

FIG. 3D is a high resolution scanning electron microscopy (SEM) image showing the surface of the carbon film with uniform hexagonal pore array. The pore size is 33.7±2.5 nm and wall thickness is 9.0±1.1 nm.

FIG. 3E is an scanning electron microscopy (SEM) image showing the film cross section, exhibiting all parallel straight channels perpendicular to the film surface.

FIG. 3F shows the Fourier Transform of the image shown in FIG. 3E.

FIG. 4 is a high-resolution transmission electron microscopy (TEM) image of the carbon wall of the carbon film.

FIG. 5 shows a wide-angle X-ray diffraction pattern of the carbon film.

FIG. 6 shows the Raman spectrum of the carbon film.

For a better understanding of the present invention, together with other and further objects, advantages and capabilities thereof, reference is made to the following disclosure and appended claims in connection with the above-described drawings.

### DETAILED DESCRIPTION OF THE INVENTION

Applicant's present invention comprises highly ordered and well-defined crack-free mesoporous carbon materials having ordered carbon nanopores that have uniform pore sizes ranging from about 4.5 nm up to about 100 nm and wherein the porous carbon films have homogeneous film thickness from several tens of nanometers up to about 1 μm. These carbon materials of Applicant's invention may also have well oriented nanostructures. Applicant's present invention further comprises a versatile methodology, a stepwise self-assembly approach for the preparation of large-scale, highly ordered and well defined carbon nanostructures in the form of membranes on substrates, free-standing film and fine particles. The carbon precursor molecules are spatially arranged into well defined nanostructures via the self-assembly of block copolymers. One unique feature of Applicant's invention is the utilization of self-assembled block copolymers as structure-directing agents for the fabrication of highly ordered carbon nanostructures. Well defined polymer nanostructures that are made through the microphase separation of block copolymers have been used to organize the carbon precursors into highly ordered nanostructures. Upon carbonization, well defined carbon nanostructures, such as hexagonal and cubic porous carbon, reverse cubic porous carbon, hexagonal carbon pillars array, cubic carbon spheres array, and lamellar carbon sheets can be made through the pyrolysis of the pre-organized carbon precursors. The block copolymers are sacrificed as voids during pyrolysis; thus no template removal is involved. The hexagonally packed carbon channel array whose orientation is normal to the carbon film surface has been successfully synthesized. Large-scale crack-free carbon films up to 6 cm² are also readily fabricated on common substrates such as silica, copper, silicon, and carbon. Tunable sizes of the periodical units can be made by using polymers of various molecular weights as templates. By Applicant's present invention, large scale nanoporous carbon films are made with homogeneous thickness. Films can be made on substrates with any size and shape. Applicant's present invention provides the method for the preparation of carbon films with well defined carbon nanostructures which cannot be achieved by any existing method.

In Applicant's present invention, “well-defined” means that the nanostructure of the porous carbon material or film has an ordered structure with repeat sub-unions of identical size and shape. All repeat sub-unions apart from the adjacent unions in defined distances. The well defined nanostructure may not necessarily be well oriented. For example, a hexagonal cylindrical porous structure may contain some pores oriented parallel to the substrate and some pores oriented perpendicular to the substrate. A well defined nanostructure may have arbitrary orientations. The term “well oriented” means the nanostructure has a certain orientation wherein all sub-unions of the nanostructure are oriented toward one direction. However, the sub-unions may apart from the adjacent sub-unions of uncertain distance. For example, if a porous structure has cylindrical pores that are perpendicular to the substrate surface, but the adjacent pores apart from each other in an arbitrary distance.

The method of Applicant's invention comprises the steps of first applying the carbon precursors to the substrates through solution casting. Nanostructures are formed via the self-assembly of the block copolymers. Afterward, the carbon precursor along with the block copolymers are pyrolyzed at high temperatures to develop well defined carbon nanostructures. Here, the block copolymers instead of inorganic templates are used as structure-directing agents, which decompose in the carbonization step. Therefore, Applicant's invention does not require any template removal step. Carbon films can be made of high purity with strong adherence to the substrates. This solvent-casting method of the present invention allows the fabrication of large scale homogeneous films on various shaped substrates without any extra efforts. The concentration and the molecular weight of the block copolymers determine the phase symmetry and the dimension of the repeat units in the carbon film. The film properties are simply controlled by the synthetic parameters. The method of Applicant's invention can also be used to form fine particles of carbon material.

Applicant's present invention provides a methodology for the preparation of carbon films as well as other carbon materials having well defined nanostructures. Proper changes in the synthetic parameters allow the production of carbon materials with various phase symmetries and dimensions in the repeat units. The essence of Applicant's present method is the utilization of block copolymers as structure-directing agents, which benefits the producing of carbon materials in two aspects. The first aspect being the nanostructure is formed through a solution casting procedure which can apply to complex shaped substrates; and the second being the block copolymers leave during carbonization. No removal of templates is required. The method of Applicant's present invention comprises the first step of solution casting wherein a solution of the block copolymer (structure directing agent) and catalyst or carbon precursor monomer is coated on the substrates to form an organic film; then, solvent annealing wherein the organic film structure is refined through the evaporation of selected solvents. Highly ordered nanostructures are formed in this step. The next step is polymerization wherein the carbon precursors are polymerized in the highly ordered organic film through vapor phase reactions; then, carbonization wherein organic materials are heated to high temperatures to yield carbon films. The block copolymers decompose in this step to generate pores.

The self-assembly of block copolymers has proven to be a versatile approach to the selective organization and nanoscale regulation of the concentration distribution of target molecular species (carbon precursors) for the fabrication of nanoporous materials. The mechanism for such organization involves hydrogen bonding, ion pairing, and/or dative interactions between supramolecular assemblies of block copolymers and target molecular species (carbon precursors). The resulting composites give rise to various nanostructures according to the structural and phase behaviors of block copolymers. The target molecular species are spatially concentrated in selected microdomains and can eventually serve as nanostructured catalysts, spacers, or precursors for the further fabrication of ordered nanostructures. Highly ordered nanoporous materials, such as polymer, silica, and organic-inorganic hybrid materials, have been created through polymerization in the presence of the self-assembled block copolymers.

Although block copolymers contain high atomic carbon concentrations, ordered nanoporous carbon films have not been successfully fabricated through the direct pyrolysis of self-assembled block copolymers. This inability is because linearly structured block copolymer compounds have very poor carbon yields in carbonization reactions. Furthermore, the survival of the nanostructures during high-temperature pyrolysis (>800° C.) is extremely challenging for the self-assembled block copolymer structures. The deficiency is associated with the linearly structured block copolymers which melt before carbonization reactions. The cross-linking of block copolymers can significantly stabilize the self-assembled nanostructures. However, it is still difficult for the limited cross-linkage to preserve the preorganized nanostructures because of the massive loss of carbon via volatile carbon-containing species during pyrolysis.

Applicant's methodology has been successfully demonstrated in fabricating ordered nanoporous carbon films through the use of block copolymers that are used to stabilize the self-assembled nanostructures. In order to demonstrate Applicant's present invention, three routes have been developed. These routes are different from each other through the arrangement of the functionalities such as monomer, catalyst, and carbon precursor. Nevertheless, Applicant's methodology is not limited to these three routes.

### EXAMPLE 1

Spatial organization of the phenolic resin monomer by block copolymers: Phenolic resin is used as carbon precursors. First, 0.1 g poly(styrene-block-(4-vinylpyridine)) (PS-P4VP), with average molecular masses (Mn) of PS 11,800 g/mol, P4VP 11,500 g/mol and Mw/Mn=1.04 for both blocks, and 0.0512 g resorcinol were dissolved in 2 g of dimethylformalamide (DMF). (Mw is the weight average molecular weight of the polymer. This solution was heated at 100° C. for 4 hours to ensure the formation of hydrogen bond. After the solution was cooled to room temperature, a drop of solution was cast into a film on a silica plate by spin coating at 1000 rpm for 2 minutes. The film was subsequently dried in a hood. The dry film along with 2 small vials which contain DMF and benzene, respectively, was then put into a preheated chamber at 80° C. The film remained in the chamber for 24 hours to allow the completion of microphase separation. The microphase separated film was dried in air and sequentially cured by exposing to formaldehyde gas 100° C. for 4 hours. The cured film was finally carbonized in nitrogen gas through a temperature ramp of 1° C./min to 800° C.

### EXAMPLE 2

Spatial organization of polymerization catalyst by block copolymers: Poly furfural alcohol was employed as carbon precursor. 0.1 g poly(ethyleneoxide-block-propyleneoxide-block-ethyleneoxide) (PEO-PPO-PEO) triblock copolymer and 0.01 g p-toluenesulfonic acid were dissolved in 2 g tetrahydrofuran (THF). A film was cast by using this solution by dip coating at 40° C. The cast film was then annealed in THF vapor in a 24 hour period. The annealed film was thoroughly dried under vacuum and then exposed to furfural alcohol gas for about 30 minutes at room temperature. A black poly(furfuryl alcohol) was formed on the film. This film was stabilized at 100° C. overnight to ensure the completion of polymerization. The film was carbonized in nitrogen gas through a temperature ramp of 1° C./min to 800° C.

### EXAMPLE 3

Spatial organization of linear polymer via the self assembly of block copolymers: Neither catalyst nor monomer was used in this route. Poly(4-hydroxyl-styrene) was used as carbon precursor after it had been cross-linked with formaldehyde. 0.1 to 20 wt % of poly(styrene-block-4-hydroxyl-styrene) in THF was cast to substrates. The structure of the film was refined in the THF vapor for 24 hours. The film was then thoroughly dried in a vacuum oven at 50° C. The dry film was cross-linked in formaldehyde gas at 80° C. for 10 hours before it had been finally carbonized through a temperature ramp of 1° C./min to 800° C. The carbonized film had an ordered nanostructure dependent upon the ratio of the two blocks. In general, with PS block in the range of less than 20 percent, the resulted carbon film has a cubic porous structure; PS block in the range of 20-40% yields hexagonal cylindrical pores; PS block in the range of 40-60% yield lamellar carbon sheets; PS block in the range of 60-80% yields carbon pillars array; PS block above 80% produce carbon spheres array.

In applicant's invention, one route uses highly cross-linked resorcinol formaldehyde resin (RFR) as a well-known carbonization source. This rigid polymeric carbon precursor can retain the preorganized structures during pyrolysis. However, the low solubility of the highly cross-linked resorcinol formaldehyde resin in solvents makes it impossible to directly blend the resorcinol formaldehyde resin with block copolymers for the formation of nanostructured resorcinol formaldehyde resin. To overcome this limitation, a stepwise assembly method to fabricate highly ordered nanoporous carbon films was developed. The essence of Applicant's method is to first preorganize the resorcinol monomers into a well-ordered nanostructured film with the assistance of polystyrene-b-poly(4-vinylpyridine) (PS-P4VP) self-assembly and solvent-induced structural annealing, which is followed by the in situ polymerization of the resorcinol monomers with formaldehyde vapor to form ordered nanostructured resorcinol formaldehyde resin. Upon carbonization, the nanostructured resorcinol formaldehyde resin is transformed into a highly ordered nanoporous carbon film with the concomitant decomposition of the PS-P4VP template to gaseous species. The synthesis method of Applicant's present invention comprises four basic steps: 1) monomer-block copolymer film casting, 2) structure refining via solvent annealing, 3) polymerization of carbon precursor, and 4) carbonization.

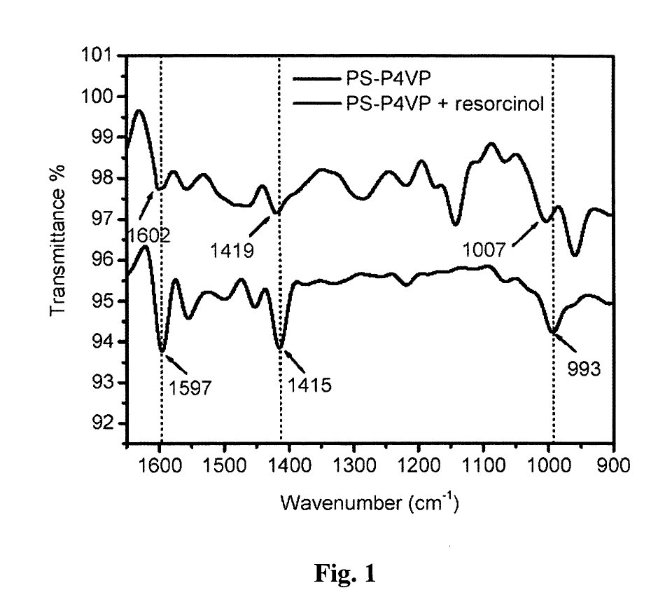

In step 1, the precursor films can be cast with a solution containing the mixture of polystyrene-b-poly(4-vinylpyridine) and resorcinol on silica, glassy carbon or copper, which can withstand the high temperature required by the final carbonization step. Both N,N′ dimethylformamide and cyclohexanol are good solvents for PS-P4VP and can be used to cast the precursor films. The concentration of PS-P4VP is in the range of 0.5-10 wt %. The final film structures are not dependent on the casting methods (dip coating and spin coating). The block copolymer template used in the synthesis has equal lengths of polystyrene and poly(4-vinylpyridine) blocks. The bulk material of this PS-P4VP copolymer has a lamellar structure. The self-assembly of PS-P4VP/resorcinol mixture is essentially driven by the hydrogen bond interaction between resorcinol and P4VP block. This strong hydrogen bond association between the basic P4VP blocks and the acidic resorcinol monomers enriches the resorcinol molecules selectively in the P4VP domain. Accordingly, the volume fraction of the P4VP domain is significantly increased relative to that of the polystyrene domain, resulting in a hexagonal structure. The polystyrene block in the PS-P4VP/resorcinol complex is the minor component, which forms cylindrical microdomains in the self-assembled film. FIG. 1 compares the Fourier transform infrared (FTIR) spectra of PS-P4VP (lower spectra) and PS-P4VP/resorcinol mixture (molar ratio of pyridine groups to resorcinol is 1:1). As seen from FIG. 1, the characteristic stetching modes of the P4VP block at 993, 1415, and 1597 cm⁻¹ shift to 1007, 1419, and 1602 cm⁻¹, respectively, for the PS-P4VP/resorcinol mixture. These vibrational frequency shifts are consistent with the interaction between the pyridine groups and the resorcinol molecules via hydrogen bonding.

The second step involves solvent annealing, which is the key to the formation of highly ordered and well-oriented nanostructures. The controlled evaporation of the solvent results in highly ordered nanostructures oriented normal to substrates. When the as-cast film is annealed in dimethylformamide/benzene vapor at 80° C. through a slow evaporation of solvents in a period of 24 hours, the final carbon film has a highly ordered hexagonal structure with all pores oriented perpendicular to the substrate. Dimethylformamide is a highly miscible solvent for both the polystyrene block and the P4VP block. When the film has swollen in dimethylformamide vapor, both blocks have quite good mobility. With this mobility, the swollen polystyrene and P4VP blocks repel one another and tend to organize into a well-defined structure. However, the repulsion of these two blocks is damped by dimethylformamide, which is highly miscible with both blocks. Applicant found that the addition of benzene vapor greatly accelerates the self-assembly process and significantly enhances the order of the film. Because benzene is a good solvent only for polystyrene block, the absorbed benzene vapor is most likely enriched in the polystyrene block domain. Therefore, the repulsion between the polystyrene and P4VP domains is enhanced by benzene. A fast microphase separation is thus achieved in the dimethylformamide and benzene mixed vapor.

In step 3, the above solvent-annealed nanostructured film was exposed to formaldehyde vapor to cross-link the resorcinol molecules into a highly cross-linked phenolic resin located in the P4VP domain. The cross-linking was carried out via vapor/solid reactions with minimum perturbation of the self-assembled nanostructures. The reaction rate can be readily controlled by the vapor pressure of formaldehyde.

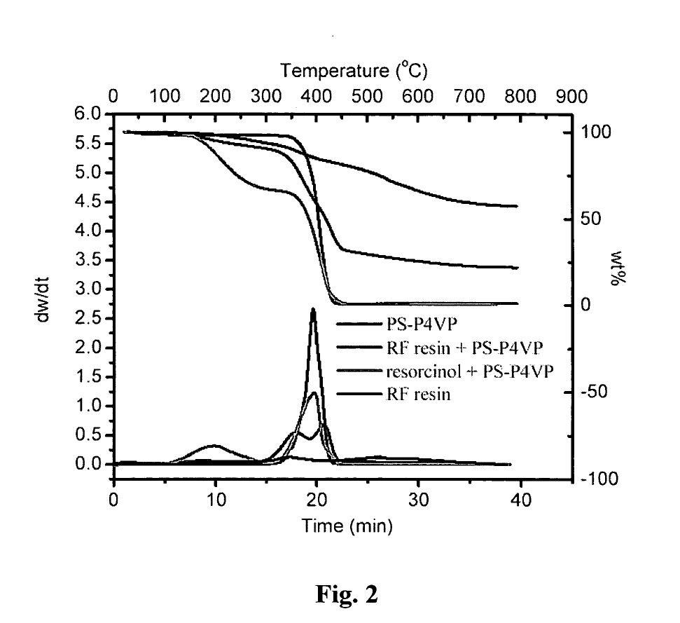

The final step involves the decomposition of the block copolymer template to generate ordered nanopores and the carbonization of the nanostructured resorcinol formaldehyde resin to form the carbon pore walls. This pyrolysis process was studied using a thernogravimetric analysis (TGA) to continuously measure the mass loss upon heating from room temperature to 800° C. under argon at 20° C./min. Shown in FIG. 2 are the thermograms (TGs) and the derivative thermograms (dTGs) of four samples: (1) PS-P4VP, (2) PS-P4VP and resorcinol mixture, (3) resorcinol formaldehyde resin, and (4) PS-P4VP and resorcinol formaldehyde resin. The pure PS-P4VP sample starts to decompose at 328° C. and ends at 430° C. with only negligible 0.7 wt % residue. Both the decomposition temperature and the reaction rate of the polystyrene and P4VP blocks are too close to be resolved in the TG and dTG curves. Therefore, the pyrolysis of PS-P4VP exhibits only one peak in the dTG curve of the pure PS-P4VP sample. The TG curve of the PS-P4VP and resorcinol mixture has two weight-loss stages with corresponding dTG peaks at 195 and 392° C. The weight loss for the first stage starts at 120° C., which is only 10° C. above the melt point of resorcinol. The first weight-loss stage ends at 284° C. with the loss of ˜34 wt %. The mixture of PS-P4VP and resorcinol has 33.87 wt % of resorcinol. Accordingly, this weight loss in the TG curve indicates that all resorcinol molecules evaporated before the temperature reached 284° C. The second weight-loss stage of the PS-P4VP/resorcinol mixture starts at 328° C. and ends at 430° C. This part of the weight loss is attributed to the decomposition of the PS-P4VP copolymer. The TGA curve of the resorcinol formaldehyde resin sample exhibits a continuous weight loss from 200° C. to 750° C. The carbonization yield for pyrolysis of resorcinol formaldehyde resin is 57.59%. The TGA curve of the PS-P4VP and resorcinol formaldehyde resin sample prepared by cross-linking the PS-P4VP/resorcinol sample via formaldehyde vapor shows a complex pyrolysis behavior. A significant weight loss was found in the range of 200° C. to 750° C. The major weight loss occurs from 320° C. to 430° C., which is attributed to the decomposition of the PS-P4VP copolymer. The two dTG peaks emerge in this zone, indicating two different composition behaviors. Comparing these peaks with the dTG peak of the pure PS-P4VP, it appears that the resorcinol formaldehyde resin affects the pyrolysis of the PS-P4VP. Because the resorcinol formaldehyde resin is localized in the P4VP domain, the decomposition of the polystyrene domain is the least affected. The P4VP chain is tangled with the resorcinol formaldehyde resin; as a result, the decomposition rate of P4VP may be retarded by resorcinol formaldehyde resin due to the interaction between the resin and P4VP. Therefore, the P4VP block may decompose after the polystyrene block. The pyrolysis of the PS-P4VP/resorcinol formaldehyde resin mixture yields 22.16% carbon at 800° C. Taking into account the weight gain in the polymerization with formaldehyde, the weight percentage of the resorcinol formaldehyde resin in the PS-P4VP/resorcinol formaldehyde resin rises from the 33.87% (resorcinol wt % in PS-P4VP/resorcinol mixture) to 37.34%. Assuming resorcinol formaldehyde resin in the P4VP domain has the same carbon yields as the pure resorcinol formaldehyde resin (57.59%), the PS-P4VP part only accounts for 1.05 wt % carbon in the fmal product. Obviously, the resorcinol formaldehyde resin is the predominant carbon source of the porous carbon film and the block copolymer is sacrificed as pores.

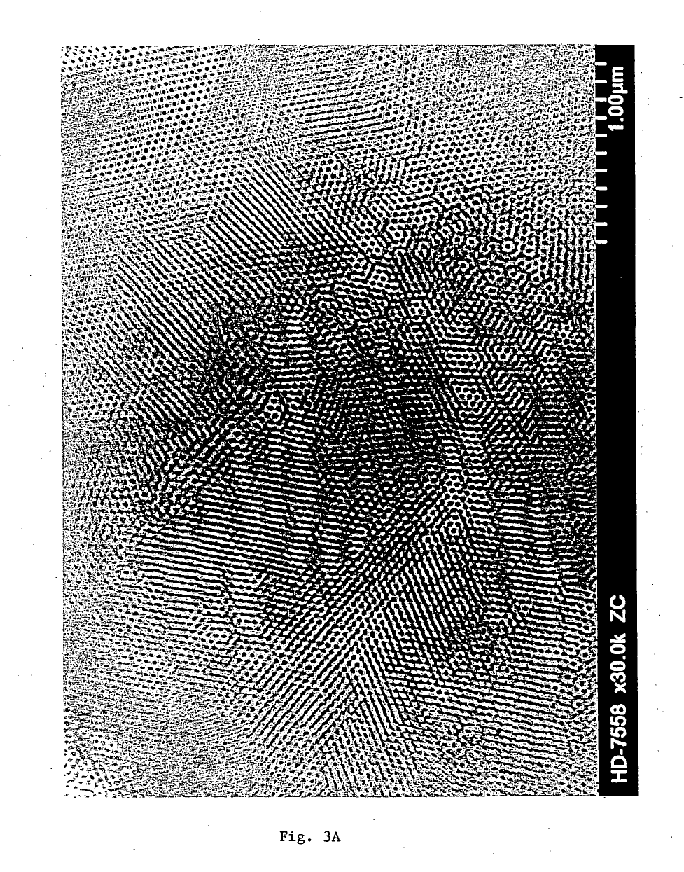

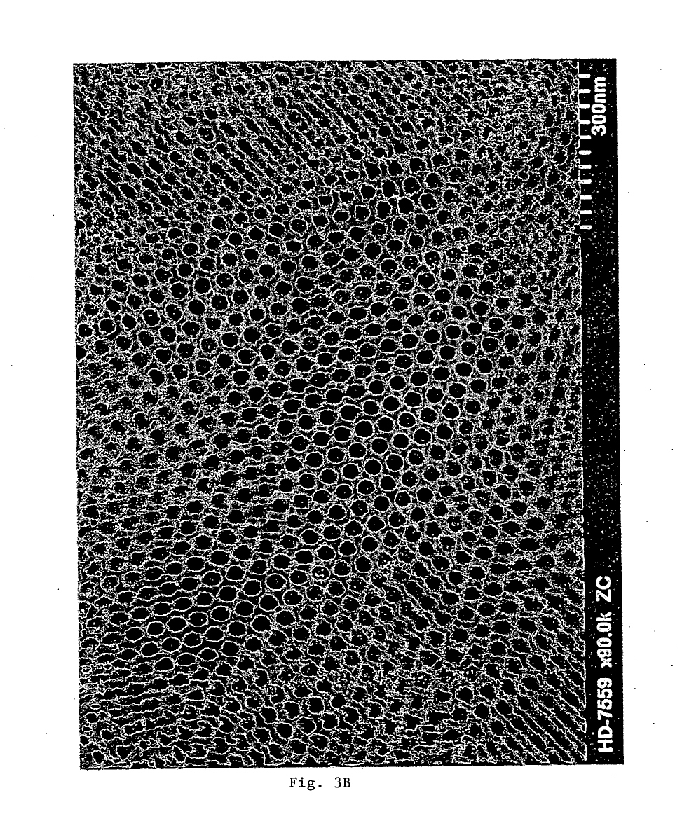

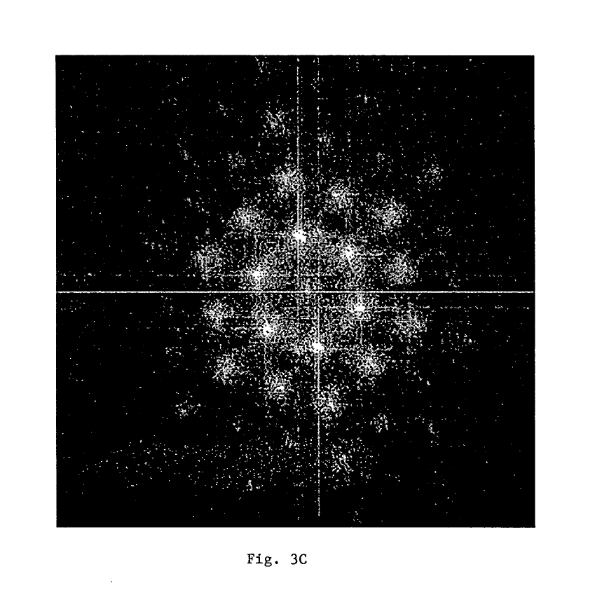

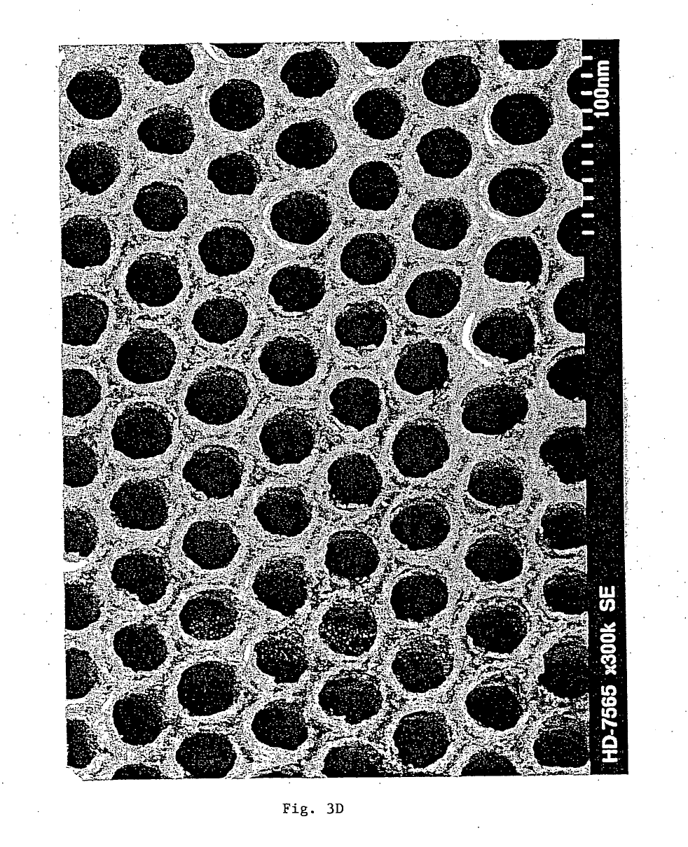

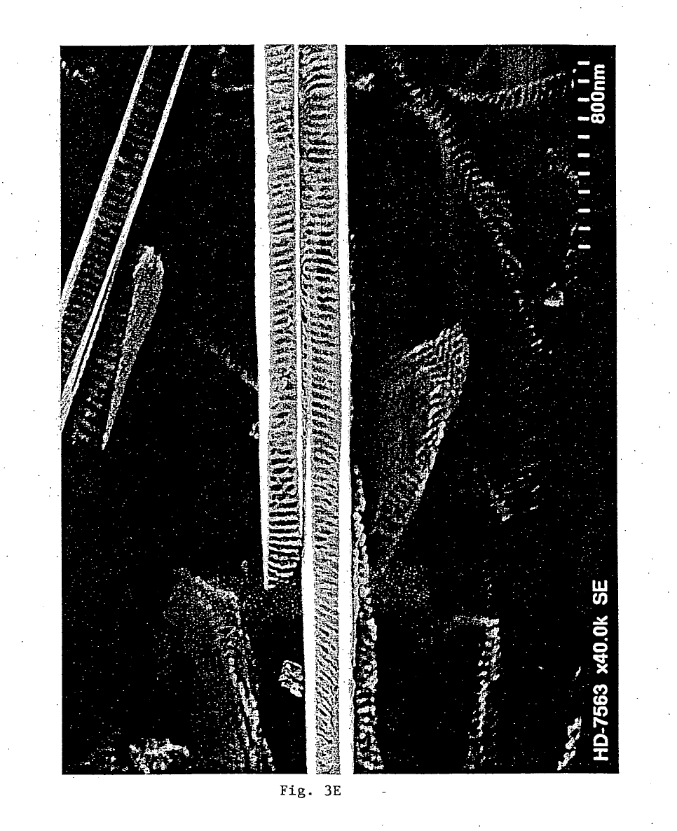

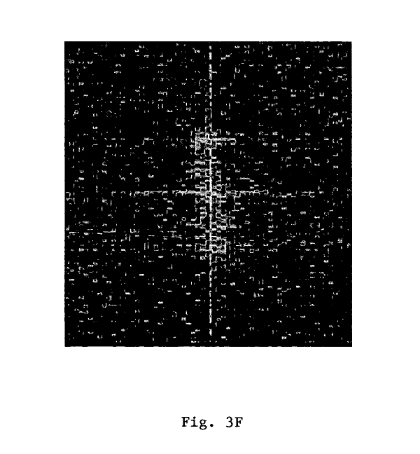

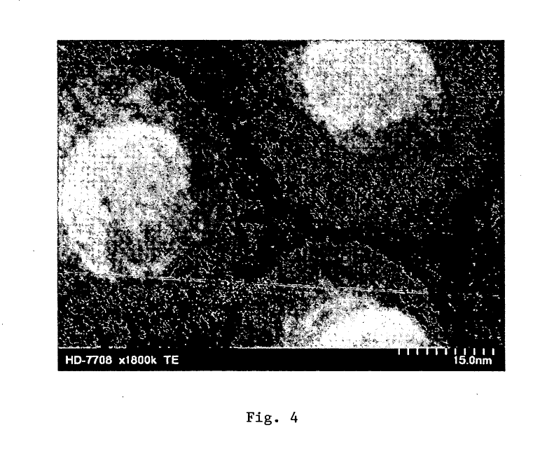

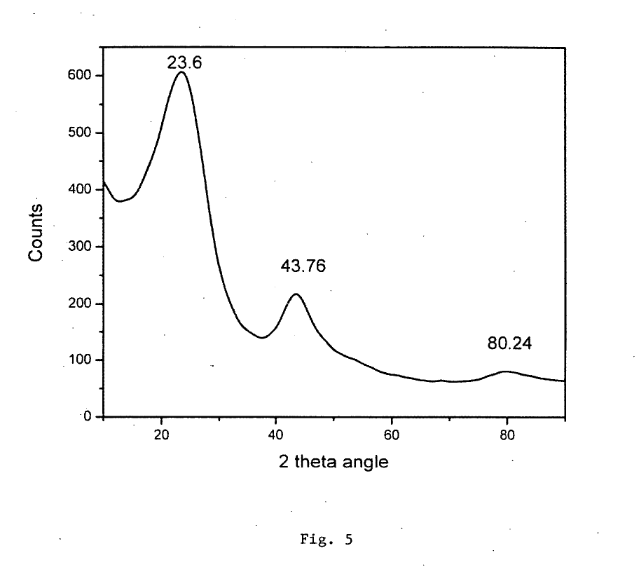

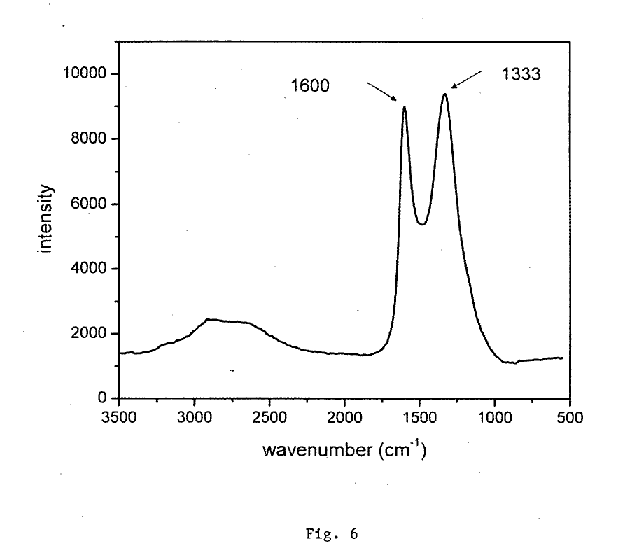

A crack-free nanoporous carbon film with thickness from several tens of nanometers up to ˜1 μm and size up to 6 cm² can be obtained. The nanoporous carbon film strongly adheres to substrates and is homogeneous in thickness. FIG. 3A is an electron microscopy Z-contrast image of the large scale homogeneous carbon film in a 4×3 μm area. The scale bar is 1 μm. FIG. 3B is an enlarged Z-contrast image showing the details of the highly ordered carbon structure. The Fourier transform (see FIG. 3C) of the Z-contrast image from FIG. 3B, shows a pattern of multiple reflections, which confirms that the film has a highly ordered hexagonal pore array. As seen from FIG. 3A and FIG. 3E, the nanopores are oriented perpendicular to the film surface. FIG. 3D is a high resolution SEM image showing the surface of the carbon film with uniform hexagonal pore array. The pore diameter is 33.7±2.5 nm and the wall thickness is 9.0±1.1 nm. The volume fraction of the straight channels is ˜0.565. The pore diameter and thickness can be controlled by the volume fractions of polystyrene in block copolymer and carbon-forming resin, respectively. A SEM image showing the cross section of the film scratched from a film substrate is shown in FIG. 3E. FIG. 3E shows all parallel straight channels perpendicular to the film surface. The Fourier transform (see FIG. 3F) of the high-resolution SEM image of the film cross section shown in FIG. 3E shows the reflections of the parallel periodical channels. No graphitic structure was found in the high-resolution TEM (HRTEM) mode, suggesting that the wall is amorphous carbon, shown in FIG. 4. Wide-angle X-ray diffraction (WAXD), FIG. 5, shows broad peaks at 23.6, 43.76, and 80.24 degrees, which are characteristic of amorphous carbon. Raman spectrum, FIG. 6, shows a broad D band at 1333 cm-1, which overlaps with the G band at 1600 cm-1. Such a broad D band is reminiscent of the glassy carbon texture.

Fine particles of porous carbon material having well defined and highly ordered nanostructures were also made by Applicant's methodology of the present invention. In this method, any spray-dry setup can be used to make these particles. Fine particles can be made by the methodology of EXAMPLE 4 below.

### EXAMPLE 4

A solution of PS-P4VP (1 to 20 wt %), resorcinol (1 to 20 wt %) in THF or DMF was feeding from the nozzle of an atomizer and spraying to a heated chamber (50° C. to 120° C.). Polymer particles were collected from the chamber after the spray. These particles were then exposed to formaldehyde gas at the temperature range of 20° C. to 120° C. for 30 minutes to 5 hours. Afterwards, the particles were carbonized in inert gas through a temperature ramp to 850° C. or higher, wherein the heating rate was 1° C. to 5° C. per minute.

Applicant's present invention can also be used to fabricate porous or mesoporous silica. A mesoporous film has pore sizes ranging from about 2 nm to about 50 nm. An example of this is given in Example 5 below.

### EXAMPLE 5

Procedure for the preparation of silica film. Tetraethoxylsilane was used as silica precursor. 0.1 g PS-P4VP and 0.08 g p-toluenesulfonic acid were dissolved in 2 g N,N′-dimethylformide (DMF). A film was cast by using this solution by dip coating at 40° C. The cast film was then annealed in DMF vapor in a 24 hour period. The annealed film was thoroughly dried under vacuum and then exposed to tetraethoxylsilane vapor at 50° C. to 100° C. for about 30 minutes. A white silica film was then formed on the substrate. This film was then calcined (carbonized) at 500° C. to decompose the block copolymer.

Another embodiment of Applicant's present invention is the synthesis of a mesoporous or porous carbon material that can be chemically or physically modified to alternate its adsorption/desorption properties. Example 6 below demonstrates how the carbon material or carbon film is chemically or physically modified.

### EXAMPLE 6

Procedure for carbon surface modification. 1 cm² of carbon film was put in 10 ml acetonitrile solution of diazonium (1 to 10 wt %) and then reduced by adding 1 ml hypophosphorous acid at 0° C. After reacted for 30 minutes to 1 hour, the solution was heated to 60° C. and was kept at this temperature for 1 hour. The film was then washed with ethanol and followed by DI water.

Another embodiment of Applicant's present invention is wherein the carbon material is fluorinated without causing any damage to the porous structure. Example 7 below gives the procedure for fluorination of carbon material or carbon film.

### EXAMPLE 7

Procedure for fluorination of carbon. 1 cm² of carbon film was put in a fluorine gas for 10 minutes to 2 days in a wide temperature range between 20° C. and 500° C. dependent on the degree of fluorination. Afterwards, the film was washed to neutral with DI water. The film was then fluorinated.

The degree of fluorination depends on the temperature and time that the film has been exposed to the fluorine gas. For example, at room temperature and reacting time 5 hours results in fluorination of 10% of the total carbon. When fluorination was conducted at 500° C. for 2 days, the fluorination will be almost 100% of the total carbon.

Another embodiment of Applicant's present invention includes the porous carbon film having a reverse cubic porous structure wherein the carbon framework is spherical, in the form of carbon spheres array. A film having a cubic nanostructure or a reverse cubic nanostructure are both referred to as having gyroidal structures.

While there has been shown and described what are at present considered the preferred embodiments of the invention, it will be obvious to those skilled in the art that various changes and modifications can be made therein without departing from the scope of the invention defined by the appended claims.

What is claimed is:

1. A method for fabricating porous carbon materials having highly ordered nanostructures comprising the steps of:
a) forming a precursor solution comprising a block copolymer template and a carbon precursor wherein said carbon precursor is spatially arranged and organized;
b) forming a self-assembled nanostructured material from said precursor solution;
c) annealing said nanostructured material thereby forming a highly ordered nanostructured material;
d) polymerizing said carbon precursor to cure said nanostructured material; and
e) pyrolyzing said nanostructured material wherein said block copolymer template is decomposed to generate ordered carbon nanopores and said nanostructured material is carbonized to form the walls of said carbon nanopores thereby forming a porous carbon material having a highly ordered nanostructure.

2. The method of claim 1 wherein said self-assembled nanostructured material is formed in step b) by casting said precursor solution onto a substrate.

3. The method of claim 2 further comprising the step of removing said porous carbon material from said substrate wherein said porous carbon material is a free-standing porous carbon material.

4. The method of claim 1 wherein said porous carbon material is crack-free.

5. The method of claim 2 wherein said porous carbon material is a film or a membrane.

6. The method of claim 1 wherein said carbon precursor is a catalyst, a monomer or a linear polymer.

7. The method of claim 2 wherein said carbon precursor is a catalyst, a monomer or a linear polymer.

8. The method of claim 2 wherein said substrate is selected from the group consisting of silica, copper, silicon, carbon and glassy carbon.

9. The method of claim 2 wherein said precursor solution is cast by dip coating or spin coating onto said substrate.

10. The method of claim 6 wherein said monomer is a phenolic resin.

11. The method of claim 7 wherein said monomer is a phenolic resin.

12. The method of claim 7 wherein said catalyst is poly furfural alcohol.

13. The method of claim 7 wherein said linear polymer is poly(4-hydroxylstyrene).

14. The method of claim 1 wherein said pyrolyzing step is performed through a temperature ramp of 1° C./min. to 800° C.

15. The method of claim 13 wherein said block copolymer template is poly(styrene-block-4-hydroxylstyrene) wherein said ordered nanostructure of said nanostructured film is dependent upon the ratio of polystyrene to poly(4-hydroxylstyrene).

16. The method of claim 15 wherein said polystyrene block is in the range of less than 20% yielding a carbon material having a cubic porous structure.

17. The method of claim 15 wherein said polystyrene block is in the range of 20-40% yielding a carbon material having hexagonal cylindrical pores.

18. The method of claim 15 wherein said polystyrene block is in the range of 40-60% yielding lamellar carbon sheets.

19. The method of claim 15 wherein said polystyrene block is in the range of 60-80% yielding carbon pillars array.

20. The method of claim 15 wherein said polystyrene block is above 80% yielding carbon spheres array.

21. The method of claim 10 wherein said block copolymer template is poly(styrene-block-(4-vinylpyridine).

22. The method of claim 11 wherein said block copolymer template is poly(styrene-block-(4-vinylpyridine).

23. The method of claim 12 wherein said block copolymer template is poly(ethyleneoxide-block-propyleneoxide-block-ethyleneoxide).

24. The method of claim 5 wherein said film is a porous silica film.

25. The method of claim 24 wherein said porous silica film is mesoporous.

26. The method of claim 1 wherein said self-assembled nanostructured material is formed in step b) by spraying said precursor solution into a heated chamber whereby nanostructured particles are formed in said heated chamber.

27. A porous carbon material comprising a carbon nanostructure having ordered carbon nanopores that have uniform pore sizes ranging from about 4.5 nm up to about 100 nm.

28. The porous carbon material of claim 27 wherein said material is crack-free.

29. The porous carbon material of claim 27 wherein said porous carbon material is a porous carbon film having homogeneous thickness from nano-scale up to about 1 μm and a size up to about 6 cm².

30. The porous carbon material of claim 27 wherein said porous carbon material is a membrane.

31. The porous carbon material of claim 29 wherein said porous carbon film is a free-standing film.

32. The porous carbon material of claim 27 wherein said porous carbon material are fine particles.

33. The porous carbon material of claim 27 wherein said porous carbon material has a cubic porous structure.

34. The porous carbon material of claim 27 wherein said porous carbon material has hexagonal cylindrical pores.

35. The porous carbon material of claim 27 wherein said porous carbon material is lamellar carbon sheets.

36. The porous carbon material of claim 27 wherein said porous carbon material is carbon pillars array.

37. The porous carbon material of claim 27 wherein said porous carbon material has a reverse cubic porous structure wherein said carbon nanostructure is in the form of carbon spheres array.

38. The porous carbon material of claim 27 is made by a method utilizing self-assembled block copolymers as structure-directing agents.

39. The porous carbon material of claim 27 wherein said porous carbon material is chemically or physically modified to alternate its adsorption/desorption properties.

40. The porous carbon material of claim 27 wherein said porous carbon material is fluorinated.
